(19) United States
(12) Patent Application Publication
(10) Pub. No.: US 2024/0193281 A1
(43) Pub. Date: Jun. 13, 2024

(54) UNIFIED ENCRYPTION ACROSS MULTI-VENDOR GRAPHICS PROCESSING UNITS

(71) Applicant: Intel Corporation, Santa Clara, CA (US)

(72) Inventors: ARDHI WIRATAMA BASKARA YUDHA, Orlando, FL (US); RESHMA LAL, Portland, OR (US)

(73) Assignee: Intel Corporation, Santa Clara, CA (US)

(21) Appl. No.: 18/065,611

(22) Filed: Dec. 13, 2022

(51) Int. Cl. G06F 21/60; H04L 9/08

(52) U.S. Cl. CPC G06F 21/602; H04L 9/085

(57) ABSTRACT

An apparatus comprises a local computer readable memory, a compute processor comprising one or more processing resources to execute a compute process, and a cryptographic processor to prefetch encrypted compute data for the compute processor and decrypt the compute data prior to making the compute data accessible to the compute processor.

### BACKGROUND

As use of HW acceleration increases for compute intensive workloads, compute service providers (CSPs) find it beneficial to maximize, or at least to increase, use of expensive hardware accelerator resources such as graphics processing units (GPUs). GPUs have become shared datacenter resource allowing servers in the data center to offload acceleration to any available GPUs. Multiple hardware vendors offer data center grade GPUs for compute workload use. Developers need to be able implement acceleration solutions that can work across all GPUs transparently, and without having to rewrite their solution of each GPU.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing environment for unified encryption across multi-vendor graphics processing units, according to embodiments.

FIG. 2 is a simplified block diagram of at least one embodiment of a computing processor core for unified encryption across multi-vendor graphics processing units, according to embodiments.

FIG. 3 is a simplified block diagram of at least one embodiment of an environment for unified encryption across multi-vendor graphics processing units, according to embodiments.

FIG. 4 is a simplified block diagram of at least one embodiment of an environment for unified encryption across multi-vendor graphics processing units, according to embodiments.

FIG. 5 is a simplified flow diagram of at least one embodiment of a method to implement unified encryption across multi-vendor graphics processing units, according to embodiments.

FIGS. 6A-6C are a simplified block diagrams of memory access patterns in a method to implement unified encryption across multi-vendor graphics processing units, according to embodiments.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

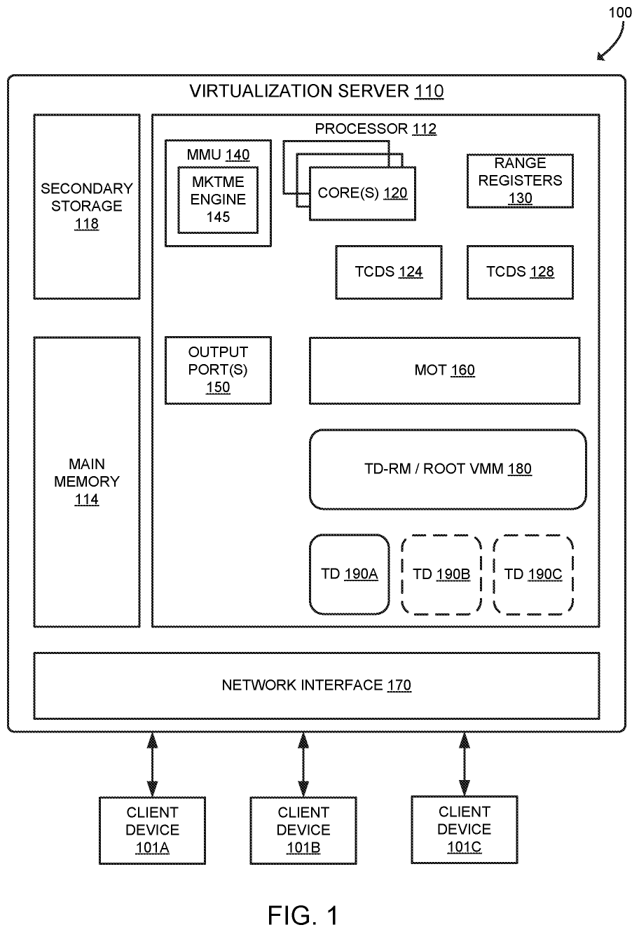

FIG. 1 is a block diagram illustrating an example computing system that provides isolation in virtualized systems using trust domains, in accordance with embodiments. The virtualization system 100 includes a virtualization server 110 that supports a number of client devices 101A-101C. The virtualization server 110 includes at least one processor 112 (also referred to as a processing device) that executes a TDRM 180. The TDRM 180 may include a VMM (may also be referred to as hypervisor) that may instantiate one or more TDs 190A-190C accessible by the client devices 101A-101C via a network interface 170. The client devices 101A-101C may include, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device.

A TD may refer to a tenant (e.g., customer) workload. The tenant workload can include an OS alone along with other ring-3 applications running on top of the OS, or can include a VM running on top of a VMM along with other ring-3 applications, for example. In implementations of the disclosure, each TD may be cryptographically isolated in memory using a separate exclusive key for encrypting the memory (holding code and data) associated with the TD.

Processor 112 may include one or more cores 120 (also referred to as processing cores 120), range registers 130, a memory management unit (MMU) 140, and output port(s) 150. FIG. 1B is a schematic block diagram of a detailed view of a processor core 120 executing a TDRM 180 in communication with a MOT 160 and one or more trust domain control structure(s) (TDCS(s)) 124 and trust domain thread control structure(s) (TDTCS(s)) 128, as shown in FIG. 1A. TDTCS and TD-TCS may be used interchangeable herein. Processor 112 may be used in a system that includes, but is not limited to, a desktop computer, a tablet computer, a laptop computer, a netbook, a notebook computer, a PDA, a server, a workstation, a cellular telephone, a mobile computing device, a smart phone, an Internet appliance or any other type of computing device. In another implementation, processor 112 may be used in a SoC system.

The computing system 100 is representative of processing systems based on micro-processing devices available from Intel Corporation of Santa Clara, Calif., although other systems (including PCs having other micro-processing devices, engineering workstations, set-top boxes and the like) may also be used. In one implementation, sample system 100 executes a version of the WINDOWS™. operating system available from Microsoft Corporation of Redmond, Wash., although other operating systems (UNIX and Linux for example), embedded software, and/or graphical user interfaces, may also be used. Thus, implementations of the disclosure are not limited to any specific combination of hardware circuitry and software.

The one or more processing cores 120 execute instructions of the system. The processing core 120 includes, but is not limited to, pre-fetch logic to fetch instructions, decode logic to decode the instructions, execution logic to execute instructions and the like. In an implementation, the computing system 100 includes a component, such as the processor 112 to employ execution units including logic to perform algorithms for processing data.

The virtualization server 110 includes a main memory 114 and a secondary storage 118 to store program binaries and OS driver events. Data in the secondary storage 118 may be stored in blocks referred to as pages, and each page may correspond to a set of physical memory addresses. The virtualization server 110 may employ virtual memory management in which applications run by the core(s) 120, such as the TDs 190A-190C, use virtual memory addresses that are mapped to guest physical memory addresses, and guest physical memory addresses are mapped to host/system physical addresses by MMU 140.

The core 120 may execute the MMU 140 to load pages from the secondary storage 118 into the main memory 114 (which includes a volatile memory and/or a nonvolatile memory) for faster access by software running on the processor 112 (e.g., on the core). When one of the TDs 190A-190C attempts to access a virtual memory address that corresponds to a physical memory address of a page loaded into the main memory 114, the MMU 140 returns the requested data. The core 120 may execute the VMM portion of TDRM 180 to translate guest physical addresses to host physical addresses of main memory and provide parameters for a protocol that allows the core 120 to read, walk and interpret these mappings.

In one implementation, processor 112 implements a TD architecture and ISA extensions (TDX) for the TD architecture. The TD architecture provides isolation between TD workloads 190A-190C and from CSP software (e.g., TDRM 180 and/or a CSP VMM (e.g., root VMM 180)) executing on the processor 112). Components of the TD architecture can include 1) memory encryption via MK-TME engine 145, 2) a resource management capability referred to herein as the TDRM 180, and 3) execution state and memory isolation capabilities in the processor 112 provided via a MOT 160 and via access-controlled TD control structures (i.e., TDCS 124 and TDTCS 128). The TDX architecture provides an ability of the processor 112 to deploy TDs 190A-190C that leverage the MK-TME engine 145, the MOT 160, and the access-controlled TD control structures (i.e., TDCS 124 and TDTCS 128) for secure operation of TD workloads 190A-190C.

In implementations of the disclosure, the TDRM 180 acts as a host and has full control of the cores 120 and other platform hardware. A TDRM 180 assigns software in a TD 190A-190C with logical processor(s). The TDRM 180, however, cannot access a TD's 190A-190C execution state on the assigned logical processor(s). Similarly, a TDRM 180 assigns physical memory and I/O resources to the TDs 190A-190C, but is not privy to access the memory state of a TD 190A due to separate encryption keys, and other integrity and replay controls on memory.

With respect to the separate encryption keys, the processor may utilize the MK-TME engine 145 to encrypt (and decrypt) memory used during execution. With total memory encryption (TME), any memory accesses by software executing on the core 120 can be encrypted in memory with an encryption key. MK-TME is an enhancement to TME that allows use of multiple encryption keys (the number of supported keys is implementation dependent). The processor 112 may utilize the MKTME engine 145 to cause different pages to be encrypted using different MK-TME keys. The MK-TME engine 145 may be utilized in the TD architecture described herein to support one or more encryption keys per each TD 190A-190C to help achieve the cryptographic isolation between different CSP customer workloads. For example, when MK-TME engine 145 is used in the TD architecture, the CPU enforces by default that TD (all pages) are to be encrypted using a TD-specific key. Furthermore, a TD may further choose specific TD pages to be plain text or encrypted using different ephemeral keys that are opaque to CSP software.

Each TD 190A-190C is a software environment that supports a software stack consisting of VMMs (e.g., using virtual machine extensions (VMX)), OSes, and/or application software (hosted by the OS). Each TD 190A-190C operates independently of other TDs 190A-190C and uses logical processor(s), memory, and I/O assigned by the TDRM 180 on the platform. Software executing in a TD 190A-190C operates with reduced privileges so that the TDRM 180 can retain control of platform resources; however, the TDRM cannot affect the confidentiality or integrity of the TD 190A-190C under defined circumstances. Further details of the TD architecture and TDX are described in more detail below with reference to FIG. 1B.

Implementations of the disclosure are not limited to computer systems. Alternative implementations of the disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processing device (DSP), system on a chip, network computers (NetPC), set-top boxes, network hubs, wide area network (WAN) switches, or any other system that can perform one or more instructions in accordance with at least one implementation.

One implementation may be described in the context of a single processing device desktop or server system, but alternative implementations may be included in a multiprocessing device system. Computing system 100 may be an example of a ‘hub’ system architecture. The computing system 100 includes a processor 112 to process data signals. The processor 112, as one illustrative example, includes a complex instruction set computer (CISC) micro-processing device, a reduced instruction set computing (RISC) micro-processing device, a very long instruction word (VLIW) micro-processing device, a processing device implementing a combination of instruction sets, or any other processing device, such as a digital signal processing device, for example. The processor 112 is coupled to a processing device bus that transmits data signals between the processor 112 and other components in the computing system 100, such as main memory 114 and/or secondary storage 118, storing instruction, data, or any combination thereof. The other components of the computing system 100 may include a graphics accelerator, a memory controller hub, an I/O controller hub, a wireless transceiver, a Flash BIOS, a network controller, an audio controller, a serial expansion port, an I/O controller, etc. These elements perform their conventional functions that are well known to those familiar with the art.

In one implementation, processor 112 includes a Level 1 (L1) internal cache memory. Depending on the architecture, the processor 112 may have a single internal cache or multiple levels of internal caches. Other implementations include a combination of both internal and external caches depending on the particular implementation and needs. A register file is to store different types of data in various registers including integer registers, floating point registers, vector registers, banked registers, shadow registers, checkpoint registers, status registers, configuration registers, and instruction pointer register.

It should be noted that the execution unit may or may not have a floating point unit. The processor 112, in one implementation, includes a microcode (ucode) ROM to store microcode, which when executed, is to perform algorithms for certain macroinstructions or handle complex scenarios. Here, microcode is potentially updateable to handle logic bugs/fixes for processor 112.

Alternate implementations of an execution unit may also be used in micro controllers, embedded processing devices, graphics devices, DSPs, and other types of logic circuits. System 100 includes a main memory 114 (may also be referred to as memory 114). Main memory 114 includes a DRAM device, a static random-access memory (SRAM) device, flash memory device, or other memory device. Main memory 114 stores instructions and/or data represented by data signals that are to be executed by the processor 112. The processor 112 is coupled to the main memory 114 via a processing device bus. A system logic chip, such as a memory controller hub (MCH) may be coupled to the processing device bus and main memory 114. An MCH can provide a high bandwidth memory path to main memory 114 for instruction and data storage and for storage of graphics commands, data and textures. The MCH can be used to direct data signals between the processor 112, main memory 114, and other components in the system 100 and to bridge the data signals between processing device bus, memory 114, and system I/O, for example. The MCH may be coupled to memory 114 through a memory interface. In some implementations, the system logic chip can provide a graphics port for coupling to a graphics controller through an Accelerated Graphics Port (AGP) interconnect.

The computing system 100 may also include an I/O controller hub (ICH). The ICH can provide direct connections to some I/O devices via a local I/O bus. The local I/O bus is a high-speed I/O bus for connecting peripherals to the memory 114, chipset, and processor 112. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

For another implementation of a system, the instructions executed by the processing device core 120 described above can be used with a system on a chip. One implementation of a system on a chip comprises of a processing device and a memory. The memory for one such system is a flash memory. The flash memory can be located on the same die as the processing device and other system components. Additionally, other logic blocks such as a memory controller or graphics controller can also be located on a system on a chip.

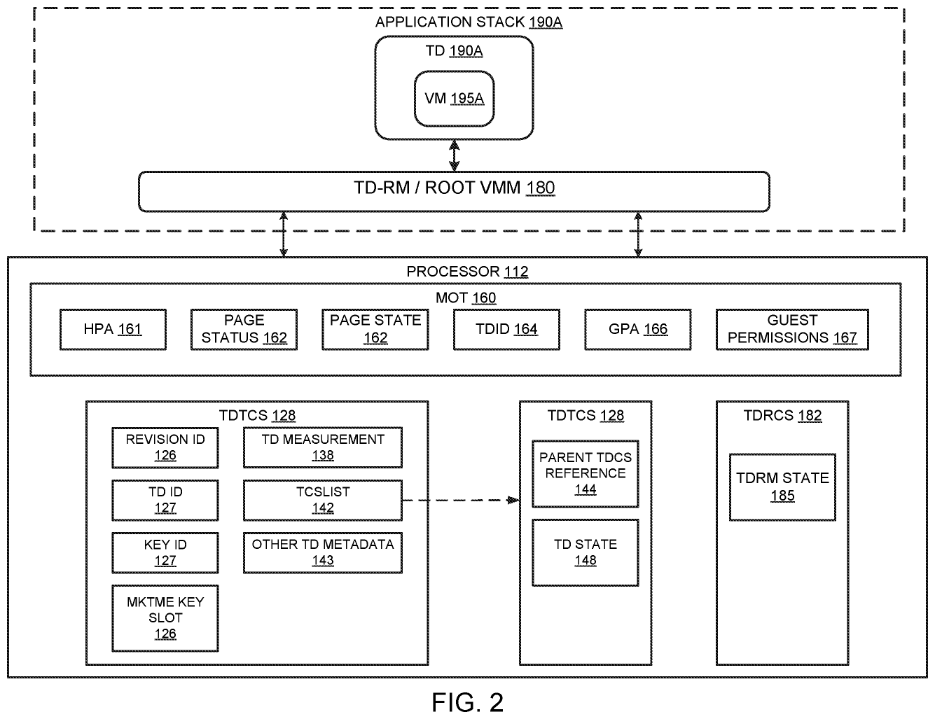

With reference to FIG. 2, this figure depicts a block diagram of the processor 112 of FIG. 1, according to one implementation of the disclosure. In one implementation, the processor 112 may execute an application stack 101 via a single core 120 or across several cores 120. As discussed above, the processor 112 may provide a TD architecture and TDX to provide confidentiality (and integrity) for customer software running in the customer/tenants (i.e., TDs 190A) in an untrusted cloud service providers (CSP) infrastructure. The TD architecture provides for memory isolation via a MOT 160; CPU state isolation that incorporates CPU key management via TDCS 124 and/or TDTCS 128; and CPU measurement infrastructure for TD 190A software.

In one implementation, TD architecture provides ISA extensions (referred to as TDX) that support confidential operation of OS and OS-managed applications (virtualized and non-virtualized). A platform, such as one including processor 112, with TDX enabled can function as multiple encrypted contexts referred to as TDs. For ease of explanation, a single TD 190A is depicted in FIG. 1B. Each TD 190A can run VMMs, VMs, OSes, and/or applications. For example, TD 190A is depicted as hosting VM 195A.

In one implementation, the TDRM 180 may include as part of VMM functionality (e.g., root VMM). A VMM may refer to software, firmware, or hardware to create, run, and manage a virtual machines (VM), such as VM 195A. It should be noted that the VMM may create, run, and manage one or more VMs. As depicted, the VMM 110 is included as a component of one or more processing cores 120 of a processing device 122. The VMM 110 may create and run the VM 195A and allocate one or more virtual processors (e.g., vCPUs) to the VM 195A. The VM 195A may be referred to as guest 195A herein. The VMM may allow the VM 195A to access hardware of the underlying computing system, such as computing system 100 of FIG. 1. The VM 195A may execute a guest operating system (OS). The VMM may manage the execution of the guest OS. The guest OS may function to control access of virtual processors of the VM 195A to underlying hardware and software resources of the computing system 100. It should be noted that, when there are numerous VMs 195A operating on the processing device 112, the VMM may manage each of the guest OSes executing on the numerous guests. In some implementations, a VMM may be implemented with the TD 190A to manage the VMs 195A. This VMM may be referred to as a tenant VMM and/or a non-root VMM and is discussed in further detail below.

TDX also provides a programming interface for a TD management layer of the TD architecture referred to as the TDRM 180. A TDRM may be implemented as part of the CSP/root VMM. The TDRM 180 manages the operation of TDs 190A. While a TDRM 180 can assign and manage resources, such as CPU, memory and input/output (I/O) to TDs 190A, the TDRM 180 is designed to operate outside of a TCB of the TDs 190A. The TCB of a system refers to a set of hardware, firmware, and/or software component that have an ability to influence the trust for the overall operation of the system.

In one implementation, the TD architecture is thus a capability to protect software running in a TD 190A. As discussed above, components of the TD architecture may include 1) Memory encryption via a TME engine having Multi-key extensions to TME (e.g., MK-TME engine 145 of FIG. 1), 2) a software resource management layer (TDRM 180), and 3) execution state and memory isolation capabilities in the TD architecture.

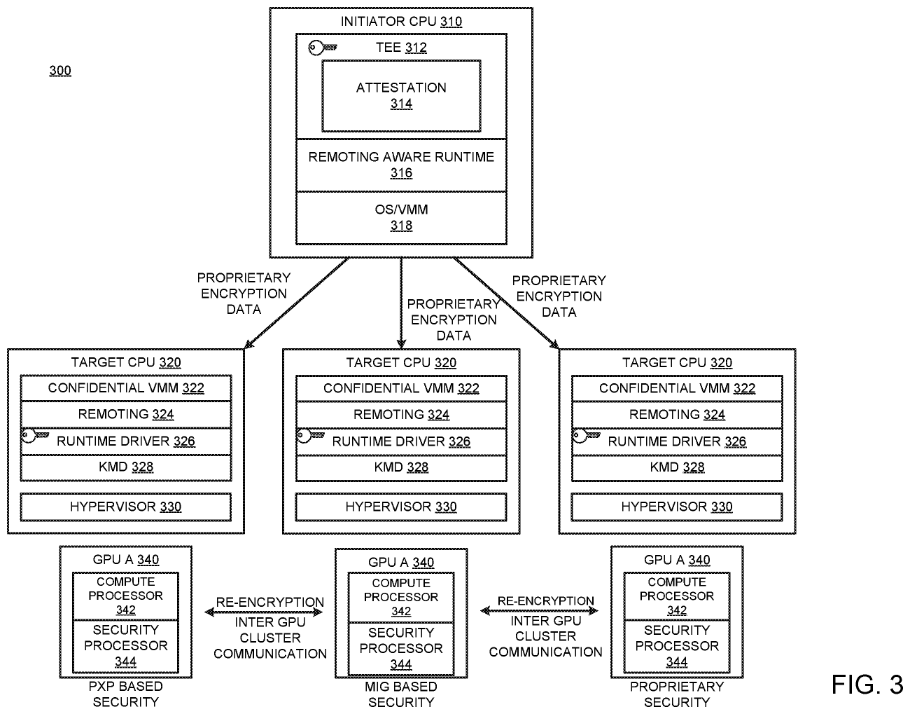

FIG. 3 is a simplified block diagram of at least one embodiment of an environment 300 for unified encryption across multi-vendor graphics processing units, according to embodiments. Referring to FIG. 3, in some examples, environment 300 comprises an initiator central processing unit (CPU) 310 communicatively coupled to a plurality of target devices which may comprise a target CPU and one or more GPUs. The initiator CPU 310 comprises a trusted execution environment 312, which may include an attestation circuitry 314, a remote aware runtime environment 316, and an operating system and/or virtual machine manager 316.

In the embodiment depicted in FIG. 3, each respective target CPU 320 comprises a confidential virtual machine manager 322, a remoting module 324, a runtime driver 326, a processor mode driver 328, and a hypervisor 330. Each respective GPU 340 comprises a compute processor 342 and a security processor 344.

In some examples, each of the respective GPUs 340 may be from a different manufacturer and may therefore implement different security protocols. For example, GPU A 340 may implement a Protected Xe Path (PXP) based security, GPU B may implement a multi-instance GPU (MIG) based security, and GPU C 340 may implement a proprietary security protocol. Thus, the initiator CPU 310 may need to provide encryption data that is proprietary to each manufacturer to the respective target CPUs to enable encryption of data in the GPUs 340. In some examples, the respective GPUs 340 may communication via an inter-GPU cluster communication connection.

As described briefly above, GPUs such as GPUs 340 have become shared datacenter resource allowing servers in the data center to offload acceleration to any available GPUs. Multiple hardware vendors offer data center grade GPUs for compute workload use. Multiple hardware vendors offer data center grade GPUs for compute workload use. Developers need to be able implement acceleration solutions that can work across all GPUs transparently, and without having to rewrite their solution of each GPU

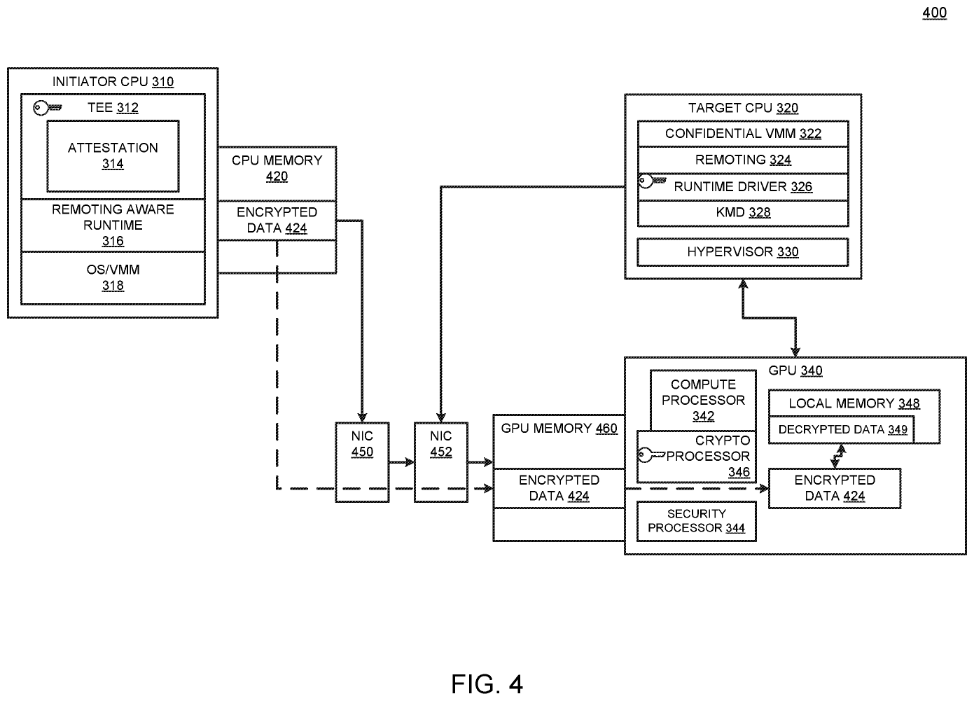

To address these and other issues, described herein are apparatus and methods to implement unified encryption across multi-vendor graphics processing units. In some examples, a GPU may comprise a compute processor to process graphics workload data and a cryptographic processor that operates in tandem with the compute processor to prefetch graphics workload data from a computer readable memory communicatively coupled to the GPU, decrypt the graphics workload data, and loads the decrypted graphics workload data into a local cache memory of the GPU, such that decrypted data is available for the compute processor in a timely fashion. Further details are described below with reference to FIGS. 4-7.

FIG. 4 is a simplified block diagram of at least one embodiment of an environment 400 for unified encryption across multi-vendor graphics processing units, according to embodiments. Referring to FIG. 4, an initiator CPU 310 is communicatively coupled to a CPU memory 420. Similarly, GPU 340 is communicatively coupled to a GPU memory 460. The In some examples, the encrypted data may comprise graphics workload data to be processed by the GPU 430. CPU 310 and associated memory 420 may be communicatively coupled to GPU 430 and associated memory via one or more network interface cards (NICs) 450, 452.

In some examples the security processor 344 implements an attestation protocol such as, for example, a security protocol and data model (SPDM) protocol to establish a shared secret key between the cryptographic processor 346 and the trusted execution environment 312 of the initiator CPU 310 such that data may be encrypted in the initiator CPU 310 and decrypted in the GPU 340. In some examples, a context identifier may be used to ensure that the shared secret key for the correct application is programmed into the cryptographic processor 346 running in the application context. This may be implemented by hardware or firmware.

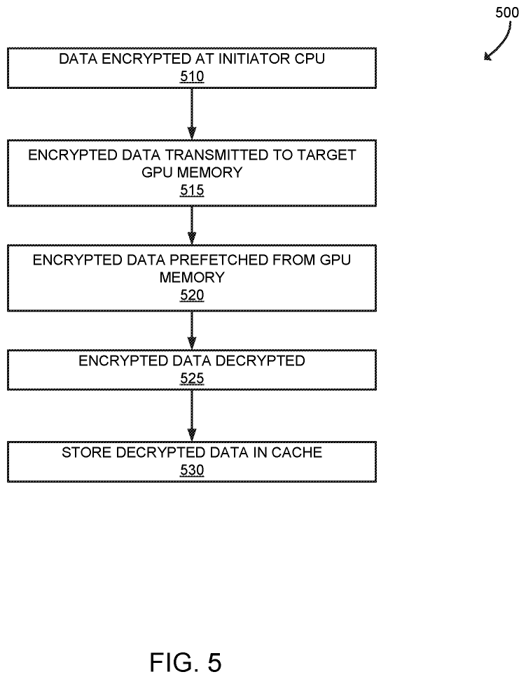

Operations implemented by the FIG. 5 is a simplified flow diagram of at least one embodiment of a method 500 to implement unified encryption across multi-vendor graphics processing units, according to embodiments. Referring to FIG. 5, at operation 510 data, (e.g., graphics workload data) is encrypted at the initiator CPU 310. In some examples the graphics workload data may be encrypted using the shared secret key in the trusted execution environment 312 that is established by attestation process implemented between the attestation module 314 and the security processor 344 to generate encrypted data 424 which is stored in the CPU memory 420.

At operation 515 the encrypted data 424 is transmitted from the CPU memory 420 to the target GPU memory 460. At operation 520 the encrypted data is prefetched from the GPU memory 460. In some examples, the cryptographic processor 346 operates in tandem with the compute processor 342 to prefetch graphics workload data for the compute processor 342. For example, assuming each thread in GPU accessing contiguous data at different iteration, the cryptographic processor may prefetch at least 128-bit of contiguous data that later will be used by the thread in the next iterations. After that, the prefetched data is decrypted, then the thread will take a portion of data that is needed in the current iteration for computation. This way, the cryptographic processor provides pre-decryption of data.

At operation 525 the encrypted data 424 is decrypted to generate decrypted data 349, which, at operation 530, is stored in the local memory 348 (e.g., cache) of the GPU 340. In some examples the cryptographic processor 346 may implement multiple different cryptographic techniques such that the cryptographic processor 346 may manage encryption/decryption for GPUs from different vendors that implement different encryption techniques. The cryptographic processor 346 is agnostic about the details of the encryption technique implemented by the initiator CPU 310. In some examples the encrypted data may be encrypted using a form of software-based encryption or other memory encryption techniques such as multi-key total memory encryption (MKTME), in which case decryption may be bypassed when the data is copied to GPU memory 460.

In some examples, encrypted data 424 is retrieved from the GPU memory 460 in 128-bit blocks. One or more techniques may be implemented if the encrypted data for a thread is less than 128 bits. On some examples, a thread may communicate with other threads via local memory or via a shfl instruction (i.e., register-register communication). In other examples, the layout of the encrypted data 424 may be modified such that a thread accesses 128 bits of data. In other examples, the encrypted data may be padded such that the encrypted data 424 occupies 128 bits of data.

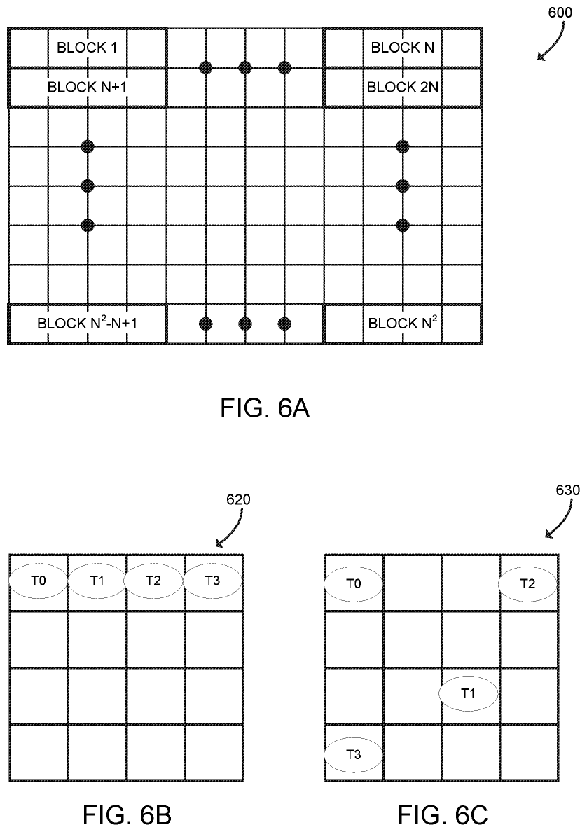

FIGS. 6A-6C are a simplified block diagrams of memory access patterns in a method to implement unified encryption across multi-vendor graphics processing units, according to embodiments. Referring to FIG. 6A, in some examples data may be encrypted on a block-by-block basis. Referring to FIG. 6B, in some examples, memory may be accessed in a regular pattern, such that the data in memory is encrypted/decrypted in a regular order. By contrast, referring to FIG. 6C, in some examples, memory may be accessed in an irregular order.

Illustrative examples of the technologies disclosed herein are provided below. An embodiment of the technologies may include any one or more, and any combination of, the examples described below.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a local computer readable memory; a compute processor comprising one or more processing resources to execute a compute process; and a cryptographic processor to prefetch encrypted compute data for the compute processor; and decrypt the compute data prior to making the compute data accessible to the compute processor.

Example 2 includes the subject matter of Example 1, further comprising a security processor to perform at least one attestation operation to establish a shared secret key with an initiator device.

Example 3 includes the subject matter of Examples 1 and 2, further comprising a computer readable memory in a communication path between the initiator device and the apparatus.

Example 4 includes the subject matter of Examples 1-3, the cryptographic processor to prefetch encrypted compute data from the computer readable memory; and decrypt the compute data to generate decrypted compute data; and load the decrypted compute data into a local computer readable memory.

Example 5 includes the subject matter of Examples 1-4, wherein the encrypted compute data is prefetched in 128-bit increments.

Example 6 includes the subject matter of Examples 1-5, the cryptographic processor to prefetch decrypted compute data from the local computer readable memory; encrypt the compute data to generate decrypted compute data; and load the decrypted compute data into a computer readable memory.

Example 7 includes the subject matter of Examples 1-6, wherein the decrypted compute data is prefetched in 128-bit increments.

Some embodiments pertain to Example 8 that includes a processor implemented method comprising executing, in a compute processor comprising one or more processing resources, a compute process; and in a cryptographic processor prefetching encrypted compute data for the compute processor; and decrypting the compute data prior to making the compute data accessible to the compute processor.

Example 9 includes the subject matter of Example 8, further comprising performing, in a security processor, at least one attestation operation to establish a shared secret key with an initiator device.

Example 10 includes the subject matter of Examples 8 and 9, a computer readable memory is disposed in a communication path between the initiator device and the apparatus.

Example 11 includes the subject matter of Examples 8-10, the cryptographic processor to perform operations comprising prefetching encrypted compute data from the computer readable memory; and decrypting the compute data to generate decrypted compute data; and loading the decrypted compute data into a local computer readable memory.

Example 12 includes the subject matter of Examples 8-11, wherein the encrypted compute data is prefetched in 128-bit increments.

Example 13 includes the subject matter of Examples 8-12, the cryptographic processor to perform operations comprising prefetch decrypted compute data from the local computer readable memory; and encrypt the compute data to generate decrypted compute data; and load the decrypted compute data into a computer readable memory.

Example 14 includes the subject matter of Examples 8-13, wherein the decrypted compute data is prefetched in 128-bit increments.

Some embodiments pertain to Example 15, that includes at least one non-transitory computer readable medium having instructions stored thereon, which when executed by a processor, cause the processor to execute, in a compute processor comprising one or more processing resources, a compute process; and in a cryptographic processor prefetch encrypted compute data for the compute processor; and decrypt the compute data prior to making the compute data accessible to the compute processor.

Example 16 includes the subject matter of Example 15, further comprising instructions which, when executed by processor, cause the processor to perform, in a security processor, at least one attestation operation to establish a shared secret key with an initiator device.

Example 17 includes the subject matter of Examples 15 and 16, wherein a computer readable memory is disposed in a communication path between the initiator device and the apparatus.

Example 18 includes the subject matter of Examples 15-17, further comprising instructions which, when executed by processor, cause the processor to further comprising instructions stored thereon that, in response to being executed, cause the cryptographic processor to:

prefetch encrypted compute data from the computer readable memory; decrypt the compute data to generate decrypted compute data; and load the decrypted compute data into a local computer readable memory.

Example 19 includes the subject matter of Examples 15-18, wherein the encrypted compute data is prefetched in 128-bit increments.

Example 20 includes the subject matter of Examples 15-19, further comprising instructions stored thereon that, in response to being executed, cause the cryptographic processor to prefetch decrypted compute data from the local computer readable memory; and encrypt the compute data to generate decrypted compute data; and load the decrypted compute data into a computer readable memory.

Example 21 includes the subject matter of Examples 15-20, wherein the decrypted compute data is prefetched in 128-bit increments.

The details above have been provided with reference to specific embodiments. Persons skilled in the art, however, will understand that various modifications and changes may be made thereto without departing from the broader spirit and scope of any of the embodiments as set forth in the appended claims. The foregoing description and drawings are, accordingly, to be regarded in an illustrative rather than a restrictive sense.

What is claimed is:

1. An apparatus, comprising:
a local computer readable memory;
a compute processor comprising one or more processing resources to execute a compute process; and
a cryptographic processor to:
prefetch encrypted compute data for the compute processor; and
decrypt the compute data prior to making the compute data accessible to the compute processor.

2. The apparatus of claim 1, further comprising:
a security processor to perform at least one attestation operation to establish a shared secret key with an initiator device.

3. The apparatus of claim 2, further comprising:
a computer readable memory in a communication path between the initiator device and the apparatus.

4. The apparatus of claim 3, the cryptographic processor to:
prefetch encrypted compute data from the computer readable memory;
decrypt the compute data to generate decrypted compute data; and
load the decrypted compute data into a local computer readable memory.

5. The apparatus of claim 4, wherein the encrypted compute data is prefetched in 128-bit increments.

6. The apparatus of claim 3, the cryptographic processor to:
prefetch decrypted compute data from the local computer readable memory;
encrypt the compute data to generate decrypted compute data; and
load the decrypted compute data into a computer readable memory.

7. The apparatus of claim 6, wherein the decrypted compute data is prefetched in 128-bit increments.

8. A method, comprising:
executing, in a compute processor comprising one or more processing resources, a compute process; and
in a cryptographic processor:
prefetching encrypted compute data for the compute processor; and
decrypting the compute data prior to making the compute data accessible to the compute processor.

9. The method of claim 8, further comprising:
performing, in a security processor, at least one attestation operation to establish a shared secret key with an initiator device.

10. The method of claim 8, wherein:
a computer readable memory is disposed in a communication path between the initiator device and the apparatus.

11. The method of claim 10, the cryptographic processor to perform operations comprising:
prefetching encrypted compute data from the computer readable memory;
decrypting the compute data to generate decrypted compute data; and
loading the decrypted compute data into a local computer readable memory.

12. The method of claim 11, wherein the encrypted compute data is prefetched in 128-bit increments.

13. The method of claim 11, the cryptographic processor to perform operations comprising:
prefetch decrypted compute data from the local computer readable memory;
encrypt the compute data to generate decrypted compute data; and
load the decrypted compute data into a computer readable memory.

14. The method of claim 13, wherein the decrypted compute data is prefetched in 128-bit increments.

15. One or more non-transitory computer-readable storage media comprising instructions stored thereon that, in response to being executed, cause a computing device to:
execute, in a compute processor comprising one or more processing resources, a compute process; and
in a cryptographic processor:
prefetch encrypted compute data for the compute processor; and
decrypt the compute data prior to making the compute data accessible to the compute processor.

16. The one or more non-transitory computer-readable storage media of claim 15, further comprising instructions stored thereon that, in response to being executed, cause the computing device to:
performing, in a security processor, at least one attestation operation to establish a shared secret key with an initiator device.

17. The one or more non-transitory computer-readable storage media of claim 15, wherein:
a computer readable memory is disposed in a communication path between the initiator device and the apparatus.

18. The one or more non-transitory computer-readable storage media of claim 17, further comprising instructions stored thereon that, in response to being executed, cause the cryptographic processor to:
prefetch encrypted compute data from the computer readable memory;
decrypt the compute data to generate decrypted compute data; and
load the decrypted compute data into a local computer readable memory.

19. The one or more non-transitory computer-readable storage media of claim 18, wherein the encrypted compute data is prefetched in 128-bit increments.

20. The one or more non-transitory computer-readable storage media of claim 17, further comprising instructions stored thereon that, in response to being executed, cause the cryptographic processor to:
prefetch decrypted compute data from the local computer readable memory;
encrypt the compute data to generate decrypted compute data; and
load the decrypted compute data into a computer readable memory.

21. The one or more non-transitory computer-readable storage media of claim 20, wherein the decrypted compute data is prefetched in 128-bit increments.
